(19) United States
(12) Patent Application Publication
(10) Pub. No.: US 2026/0237857 A1
(43) Pub. Date: Aug. 13, 2026

(54) Separators with Ion-Exchange Layers and Electrochemical Cells Comprising Such Separators

(71) Applicant: Zelos Energy Ltd., San Leandro, CA (US)

(72) Inventors: Pavel Khokhlov, San Ramon, CA (US); Alireza Ahmadiparidari, Oakland, CA (US); Alexander Sasha Gorer, Brisbane, CA (US); Pravati Swain, Foster City, CA (US)

(21) Appl. No.: 19/415,343

(22) Filed: Dec. 10, 2025

Related U.S. Application Data
(63) Continuation-in-part of application No. 18/800,747, filed on Aug. 12, 2024.

(51) Int. Cl. H01M 50/497; H01M 4/02; H01M 4/24; H01M 4/26; H01M 10/28; H01M 50/403; H01M 50/414; H01M 50/451; H01M 50/491

(52) U.S. Cl. CPC H01M 50/497; H01M 4/244; H01M 4/26; H01M 10/28; H01M 50/403; H01M 50/414; H01M 50/451; H01M 50/491; H01M 2004/027; H01M 2004/028

(57) ABSTRACT

An electrochemical cell (e.g., zinc-based cell) comprises a positive electrode, a negative electrode, and a separator positioned therebetween. The separator comprises a porous substrate and an ion exchange layer supported on the substrate. The ion exchange layer may penetrate into 1-100% of the substrate thickness to form a mechanically integrated composite that resists zinc dendrite penetration while permitting ionic transport. The ion exchange layer may be substantially non-porous or microporous with pores smaller than 1 micrometer and may include functional groups selected to provide cation or anion selectivity. Experimental results demonstrate enhanced flexibility, improved chemical stability in alkaline electrolyte, and improved mechanical performance compared to standalone ion-exchange films.

### CROSS-REFERENCE TO RELATED APPLICATIONS

This application is a continuation-in-part of a U.S. patent application Ser. No. 18/800,747, filed on 2024 Aug. 12, which is incorporated herein by reference in its entirety for all purposes.

### FIELD OF TECHNOLOGY

The present disclosure relates generally to the field of batteries and components for batteries. More specifically, the present disclosure relates to electrochemical cells that include various combinations of ion exchange layers and substrates, supporting these ion exchange layers.

### BACKGROUND

Electrochemical cells, such as zinc-based alkaline batteries, rely on separators to electrically isolate the positive and negative electrodes while permitting ionic transport through an electrolyte. Conventional porous polymer separators, including cellulose, polyethylene, and polypropylene films, provide sufficient mechanical strength but lack chemical selectivity. As a result, undesirable ionic species can migrate between the anode and cathode, leading to parasitic reactions, reduced coulombic efficiency, and accelerated capacity fade. Moreover, the porous structure of such separators allows zinc dendrites to grow through the separator during cycling, often resulting in internal short circuits and catastrophic failure.

Ion-exchange membranes have been investigated to address ion crossover by selectively permitting the transport of desired ions while blocking others. While these films can improve selectivity, standalone thin ion-exchange membranes are mechanically brittle, prone to cracking, and lack the robustness to accommodate electrode swelling during repeated cycling. Furthermore, many ion-exchange materials degrade or swell excessively in concentrated alkaline electrolytes such as potassium hydroxide solutions, leading to loss of dimensional stability and early failure.

Other approaches, such as ceramic-coated separators, have been used to improve mechanical durability. However, these coatings do not provide ion selectivity and still permit uncontrolled migration of ionic species. Similarly, multilayer laminates and reinforced films have shown partial improvement, but they generally suffer from a trade-off between flexibility, chemical stability, and selective transport. As a result, there remains a need for separators that combine mechanical robustness, dendrite suppression, chemical stability in alkaline environments, and controlled ionic selectivity, without sacrificing the energy density of the electrochemical cell.

### SUMMARY

An electrochemical cell (e.g., zinc-based cell) comprises a positive electrode, a negative electrode, and a separator positioned therebetween. The separator comprises a porous substrate and an ion exchange layer supported on the substrate. The ion exchange layer may penetrate into 1-100% of the substrate thickness to form a mechanically integrated composite that resists zinc dendrite penetration while permitting ionic transport. The ion exchange layer may be substantially non-porous or microporous with pores smaller than 1 micrometer and may include functional groups selected to provide cation or anion selectivity. The substrate may be hydrophilic while the ion exchange layer is hydrophobic, or vice versa, providing asymmetric wettability, or both layers can be hydrophilic. Experimental results demonstrate enhanced flexibility, improved chemical stability in alkaline electrolyte, and improved mechanical performance compared to standalone ion-exchange films.

Clause 1. An electrochemical cell comprising: a positive electrode comprising manganese dioxide as a positive active material; a negative electrode comprising one or more of zinc and zinc oxide as a negative active material; and a separator positioned between the positive electrode and the negative electrode, wherein: the separator comprises a porous substrate and an ion exchange layer supported on at least one side of the substrate, the substrate comprises a material selected from the group consisting of glass, polyethylene, polypropylene, cellulose, resin, and polyamide, the ion exchange layer comprises one or more functional groups selected from a carboxylic acid group, a quaternary ammonium group, an ammonium group, a phosphonium group, a sulfonium group, and the ion exchange layer faces the negative electrode.

Clause 2. The electrochemical cell of clause 1, wherein the ion exchange layer is substantially non-porous with a porosity less than 5%.

Clause 3. The electrochemical cell of clause 1, wherein the substrate has a porosity between 40-80% before coating with the ion exchange layer.

Clause 4. The electrochemical cell of clause 1, wherein the ion exchange layer penetrates at least 20% of the thickness of the substrate and forms an interpenetrating interface.

Clause 5. The electrochemical cell of clause 1, wherein the ion exchange layer fills substantially all pores in the substrate.

Clause 6. The electrochemical cell of clause 1, wherein the ion exchange layer is microporous with pore sizes smaller than 1 micrometer.

Clause 7. The electrochemical cell of clause 1, wherein the ion exchange layer has a thickness of 1-10 micrometers.

Clause 8. The electrochemical cell of clause 1, wherein the substrate has a thickness between 1-50 micrometers.

Clause 9. The electrochemical cell of clause 1, wherein the substrate is hydrophilic, and the ion exchange layer is hydrophobic.

Clause 10. The electrochemical cell of clause 9, wherein the negative electrode further comprises additives selected from bismuth oxide, indium oxide, or aluminum oxide.

Clause 11. The electrochemical cell of clause 1, wherein the separator exhibits elongation at break greater than 20%.

Clause 12. The electrochemical cell of clause 1, wherein the substrate comprises a non-woven polymeric layer.

Clause 13. The electrochemical cell of clause 1, wherein the separator comprises an additional ion exchange layer such that the porous substrate is positioned between the ion exchange layer and the additional ion exchange layer.

Clause 14. The electrochemical cell of clause 13, wherein the ion exchange layer and the additional ion exchange layer have different thicknesses.

Clause 15. The electrochemical cell of clause 1, wherein the ion exchange layer comprises a base polymer such that one or more functional groups are on 10-50% of the repeating units of the base polymer.

Clause 16. The electrochemical cell of clause 15, wherein the base polymer is selected from the group consisting of polystyrene, polysulfone, polyethersulfone, and polyphenylene oxide.

Clause 17. The electrochemical cell of clause 1, wherein the ion exchange layer exhibits an electrolyte absorption rate of less than 5%.

Clause 18. The electrochemical cell of clause 1, wherein the substrate absorbs at least 20% of its weight in electrolyte.

Clause 19. A method of fabricating an electrochemical cell, the method comprising: fabricating a positive electrode comprising manganese dioxide as a positive active material; fabricating a negative electrode comprising one or more of zinc and zinc oxide as a negative active material; fabricating a separator comprising a substrate and an ion exchange layer supported on at least one side of the substrate, wherein: the substrate comprises a material selected from the group consisting of glass, polyethylene, polypropylene, cellulose, resin, and polyamide, the ion exchange layer comprises one or more functional groups selected from a carboxylic acid group, a quaternary ammonium group, an ammonium group, a phosphonium group, a sulfonium group; and arranging the positive electrode, the separator, and the negative electrode such that the separator is positioned between the positive electrode and the negative electrode and such that the ion exchange layer faces the negative electrode.

Clause 20. The method of clause 19, wherein fabricating the separator comprises: preparing an ion-exchange solution, coating the ion-exchange solution onto the substrate such that the ion-exchange solution penetrates at least 20% of the thickness of the substrate and forms an interpenetrating interface; and drying the ion-exchange solution to form the ion exchange layer.

These and other examples are described further below with reference to the figures.

### BRIEF DESCRIPTION OF THE DRAWINGS

Non-limiting and non-exhaustive examples of the present disclosure are described with reference to the following figures, wherein like reference numerals refer to like parts throughout the various figures unless otherwise specified.

FIG. 1A is a schematic cross-sectional view of an electrochemical cell comprising a separator positioned between a positive electrode and a negative electrode and comprising a substrate and an ion exchange layer, in accordance with some examples.

FIG. 1B is a block diagram of the electrochemical cell in FIG. 1A, in accordance with some examples.

FIG. 2A is a schematic cross-sectional view of a separator comprising a substrate and a substrate-supported ion exchange layer, in accordance with some examples.

FIG. 2B is a schematic cross-sectional view of a separator comprising a substrate and two substrate-supported ion exchange layers, in accordance with some examples.

FIG. 3 is a process flowchart of a method for fabricating an electrochemical cell comprising a separator positioned between a positive electrode and a negative electrode and comprising a substrate and an ion exchange layer, in accordance with some examples.

FIGS. 4A and 4B compare the mechanical properties of a standalone ion exchange film (FIG. 4A) and a separator comprising a substrate and an ion exchange layer coated on the substrate (FIG. 4B).

FIG. 4C illustrates test results for the two types of cells (i.e., the thicker layer of the ion exchange material of the separator facing either the negative electrode or the positive electrode) subjected to various constant current discharge rates with a 0.7V lower cutoff voltage.

### DETAILED DESCRIPTION

### Introduction

Electrochemical cells, particularly those employing zinc-based chemistries, continue to face persistent challenges that limit cycle life and reliability. Among these challenges, the uncontrolled growth of zinc dendrites is especially problematic, as dendrites readily penetrate porous polymer separators, creating internal short circuits and catastrophic failure of the cell. In addition, conventional separators do not control the passage of ionic species across the cell, allowing parasitic reactions between electrodes that reduce coulombic efficiency and accelerate performance degradation.

Ion-exchange membranes have been explored as a means to provide ionic selectivity, but these materials suffer from significant shortcomings. Standalone thin ion-exchange films are typically not strong enough and brittle, making them unsuitable for cells in which electrode volume changes occur during cycling. In zinc chemistries, swelling and contraction of the negative electrode impose stresses that such membranes cannot withstand, leading to cracking and premature failure. Furthermore, ion-exchange films often degrade in concentrated alkaline electrolytes, such as potassium hydroxide, through processes such as swelling, embrittlement, or dissolution. The deficient mechanical properties also make the thin ion exchange membranes difficult to manipulate with existing cell assembly equipment.

The present disclosure provides separators designed as composite structures that combine a mechanically robust porous substrate with a selectively functionalized ion-exchange layer. The porous substrate imparts structural strength and flexibility, while the ion-exchange layer introduces controlled ionic transport pathways. In some examples, the ion-exchange layer penetrates into 1-100% of the substrate thickness, forming an interpenetrating interface that mechanically anchors the two layers together. This architecture yields a separator that resists dendrite penetration, maintains structural integrity in alkaline electrolytes, and retains sufficient flexibility to accommodate dimensional changes during cycling.

In addition to mechanical reinforcement, the disclosed separators enable selective ion transport. By tailoring functional groups in the ion-exchange layer, the separator can be rendered anion-selective or cation-selective, thereby controlling the passage of hydroxide, zincate, or other ionic species. In further examples, the separator design incorporates asymmetric wettability: a hydrophilic substrate that absorbs electrolyte and a hydrophobic ion-exchange layer that resists liquid intrusion. This combination further enhances dendrite suppression and ionic conductivity.

Experimental results confirm the improved performance of these composite separators. Compared to standalone ion-exchange films, which fractured after less than 10% elongation, the composite design demonstrated over 150% elongation before breakage, illustrating enhanced flexibility. In alkaline soak tests, the composite separators remained dimensionally stable, while standalone ion-exchange films degraded. By employing ion-exchange layers as thin as 2-10 μm, the disclosed separators also preserve high energy density, minimizing volume penalty within the cell. Together, these attributes provide a practical pathway to high-performance zinc-based batteries and other electrochemical cells requiring stable, selective, and mechanically durable separators.

### Electrochemical Cells

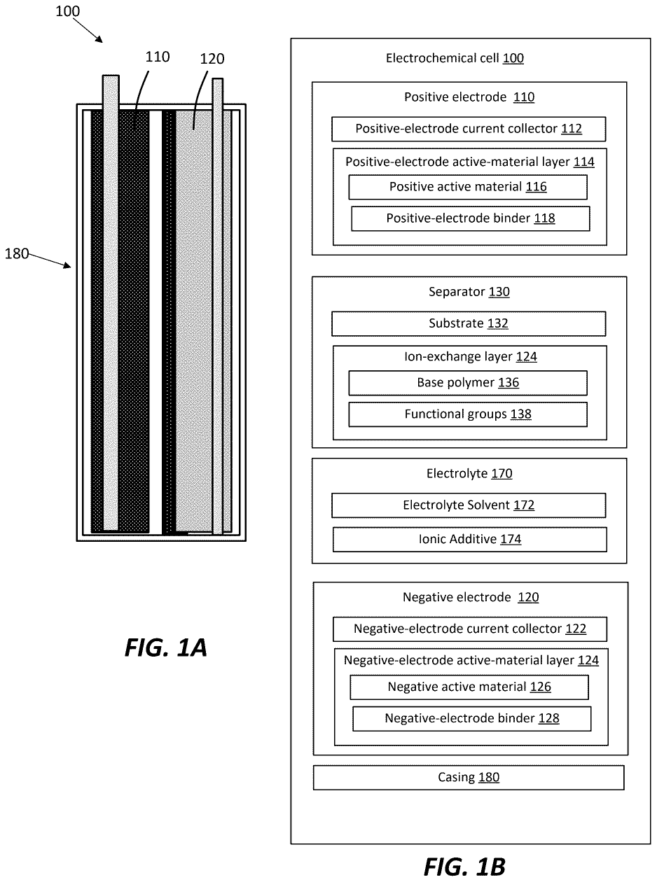

FIG. 1A is a schematic illustration of an electrochemical cell 100, which may also be referred to as an electrochemical battery or a battery, in accordance with some examples. FIG. 1B is a block diagram of the electrochemical cell 100 illustrating various components, in accordance with some examples. The type of electrochemical cell 100 is determined by the composition of its electrodes, as further described below.

The battery cells of this invention can have any of a number of different shapes and sizes. For example, coin, prismatic, pouch, or cylindrical cells can be used. Cylindrical cells of this invention may have the diameter and length of conventional AAA cells, AA cells, A cells, C, or D cells. Custom cell designs can be used in some applications. For example, prismatic cell designs can be used for portable or vehicular applications, as well as various larger format cells employed for various non-portable applications. A battery pack can be specifically designed for particular tools or applications. Battery packs can include one or more battery cells and appropriate casing, contacts, and conductive lines to permit reliable charge and discharge in an electric device. In some examples, electrodes can be sized to exactly fit within a casing of conventional AAA cells, AA cells (e.g., bobbin-style AA cells), A cells, C, D cells, or other known or custom cell sizes. This disclosure covers the manufacture and placement into a casing of a monolithic anode, including at least one of zinc or zinc oxide, and sized to match the casing exactly.

An electrochemical cell 100 comprises a positive electrode 110, a negative electrode 120, and a separator 130 positioned between and electronically isolating the positive electrode 110 and the negative electrode 120. The electrochemical cell 100 also comprises an electrolyte 170, which provides ionic transfer between the positive electrode 110 and the negative electrode 120. At least a portion of the electrolyte 170 may soak into the separator 130. Finally, the electrochemical cell 100 may also comprise casing 180 that surrounds/encloses various battery components (e.g., listed above).

### Positive Electrodes

Referring to FIG. 1B, the positive electrode 110 may comprise a positive-electrode current collector 112 and a positive-electrode active-material layer 114, supported on the positive-electrode current collector 112. However, other structures of the positive electrode 110 are within the scope. In some examples, the cell enclosure may serve as a current collector for the positive electrode 110, such as in cells with a bobbin design. In some examples, the positive-electrode current collector 112 is embedded into the positive-electrode active-material layer 114. Some examples of materials suitable for a positive-electrode current collector 112 include, but are not limited to, nickel (Ni), nickel alloy, steel and stainless steel (SS), and carbon materials. A positive-electrode current collector 112 may be in the form of a foil, mesh, felt, fabric, or foam. In general, current collectors serve to supply an electric current so that it can be consumed for the electrode reaction during charge and collect an electric current generated during discharge.

In some examples, a positive active material 116 include, but are not limited to, one or more of metal metal-containing compounds, e.g., comprising Fe⁶⁺, Mn⁷⁺, nickel hydroxide (Ni(OH)₂), nickel oxyhydroxide (NiOOH), manganese dioxide (MnO₂), copper oxide, bismuth oxide, air electrodes, carbons, activated carbons, or any combinations. Examples of Mn⁷⁺-containing materials include, but are not limited to, potassium permanganate (KMnO₄), sodium permanganate (NaMnO₄). Examples of Fe⁶⁺-containing materials include, but are not limited to, potassium ferrate (K₂FeO₄) and barium ferrate (BaFeO₄).

In some examples, a positive active material 116 is manganese dioxide (MnO₂) (charged state) or, more specifically, electroplated manganese dioxide (EMD), e.g., in ZnMn battery cells. In additional examples (Zn—Ni cells), a positive active material 116 is nickel hydroxide (Ni(OH)₂) or nickel oxyhydroxide (NiO(OH)), e.g., in ZnNi battery cells. These examples of positive active material 116 provide high electron-capacity (mAh/g), stability in high alkalinity, safety, and are easy to produce and recycle. For example, manganese (Mn) is not toxic. Furthermore, EMD is a highly purified and structurally controlled form of manganese dioxide (MnO₂) that enhances the reliability and consistency of battery cell performance. EMD's porous, high-surface-area morphology improves electrolyte penetration and enables greater utilization of the active material, resulting in higher discharge capacity and improved rate capability. The γ-MnO₂ phase prevalent in EMD exhibits superior electrochemical activity and stability, supporting efficient proton and zinc-ion insertion processes in aqueous battery chemistries. Finally, EMD's robust microstructure also provides mechanical durability and resistance to degradation, enabling improved cycle life relative to chemically synthesized manganese oxides.

More broadly, cathode materials can include: (a) any metal M having a redox potential EO larger than the redox potential of the anode material; (b) any metal oxide MOx having a redox potential EO larger than the redox potential of the anode material; (c) any alloy of any metals MM1M2 . . . Mn having an EO larger than the EO of the anode material; (d) any metal fluoride MFn having a redox potential larger than the anode material; (e) any alloy MM1M2 . . . MnOxFm with n larger or equal to 2 and m being larger or equal to zero; (f) any polymer that can accommodate anions in its structure having a redox potential EO larger than the redox potential of the anode material; (g) CFx carbon fluoride with x being between zero and 2; (h) unstable salts not stable in aqueous electrolyte solutions, including but not limited to FeVI (iron six) based battery systems; (i) any type of carbon (including activated carbons, high surface area carbons or graphites; and (j) any mixture of one or more of the above mentioned type of materials.

Unless specifically noted, negative active materials 126 and positive active materials 116 are described at an electrode fabrication state and/or while the electrochemical cell 100 is being assembled (i.e., before initial cycling). One having ordinary skill in the art would appreciate that the composition of the negative active materials 126 and positive active materials 116 changes as the electrochemical cell 100 cycles (charges/discharges).

One or both positive electrode active materials layer 114 and negative electrode active materials layer 124 may be solid porous structures (e.g., comprising continuous pores). In some examples, one or both of these layers comprises multiple interconnected three-dimensional channels that form a highly porous, rigid, monolithic, and/or sponge-like structure.

In some examples, one or both positive electrode active materials layer 114 and negative electrode active materials layer 124 may be in the form of thin films or structured patterns such as columns, needles, grooves, or slots. The active materials (e.g., positive active material 116 and/or negative active material 126) may be loosely arranged structures (e.g., supported by binders, such as positive electrode binder 118 and/or negative electrode binder 128) or rigidly bound/sintered structures. For example, positive electrode binder 118 and/or negative electrode binder 128 may be in the form of structures such as powders, granules, pellets, fibers, gel, or nanomaterial. In specific examples, particles can have an average size (diameter or longest dimension) of 0.05-300 micrometers or, more specifically, 0.3-50 micrometers.

### Negative Electrodes

Referring to FIG. 1B, the negative electrode 120 comprises a negative-electrode current collector 122 and a negative-electrode active-materials layer 124, supported on the negative-electrode current collector 122. In some examples, the cell enclosure may serve as a current collector for the negative electrode, such as in cells with a bobbin design. In some examples, the negative-electrode current collector 122 is embedded into the negative-electrode active-materials layer 124. Some examples of materials suitable for a negative-electrode current collector 122 include, but are not limited to, copper (Cu), tin (Sn), tin-plated copper, and zinc (Zn). A negative-electrode current collector 122 may be in the form of a foil, mesh, felt, fabric, foam, and/or a wire.

In some examples, a negative active material 126 comprises one or more of zinc metal (Zn) and zinc oxide (ZnO). For example, the negative active material 126 comprises a mixture of zinc (Zn) and zinc oxide (ZnO). Specifically, zinc metal (Zn) may be referred to as a primary or secondary active material (e.g., being the main source of electrochemical energy). Zinc oxide (ZnO) has a dual role: (a) a primary or secondary active material (e.g., participating in charge-discharge cycling) and (b) a viscosity adjuster in the slurry during mixing. In some examples, the negative active material 126 represents at least 60%, at least 70%, or even at least 80% by weight of the negative-electrode active-materials layer 124. For example, one or a combination of zinc metal (Zn) and zinc oxide (ZnO) may form 70-99% or, more specifically, 80-95% of the negative-electrode active-materials layer 124. For example, zinc oxide (ZnO) may form 1-25% or, more specifically, 5-20% by weight of the negative-electrode active-materials layer 124, while zinc metal (Zn) may form the remainder, e.g., 75-98% or, more specifically, 80-95% by weight. Adding zinc oxide (ZnO) to zinc metal (Zn) in alkaline cells improves battery performance by enhancing cycle life, increasing stability, and mitigating issues like dendrite growth and shape change. Zinc oxide (ZnO) helps to create a more uniform and porous zinc deposit during charging, which leads to better charge capacity and longer battery life. Zinc oxide (ZnO) also helps regulate ion concentration gradients, preventing the zinc from dissolving and reforming unevenly.

In some examples, zinc (Zn) is used as a negative active material 126 without zinc oxide (ZnO), e.g., the negative-electrode active-materials layer 124 is free from zinc oxide (ZnO). Alternatively, zinc oxide (ZnO) is used as a negative active material 126 without zinc (Zn), e.g., the negative-electrode active-materials layer 124 is free from zinc (Zn).

The zinc oxide (ZnO) can dissolve in an alkaline electrolyte to form the zincate (Zn(OH)₄²⁻). Sinc oxide (ZnO) and/or zincate (Zn(OH)₄²⁻) is reduced to zinc metal during the charging process.

### Electrode Binders

As noted above, one or both electrodes may include binders, e.g., positive electrode binder 118 and/or negative electrode binder 128. Some examples, polytetrafluoroethylene (PTFE), polyethylene (PE), polypropylene (PP), polyisobutylene (PIB), polyvinyl alcohol (PVA), polyacrylic acid, polyvinyl acetate, carboxymethyl cellulose (CMC), styrene-butadiene rubber (SBR), polyethylene oxide (PEO), polybutylene terephthalate (PBT) or polyamides, polyvinylidene fluoride (PVDF), silicone-based elastomers such as polydimethyl siloxane (PDMS) or rubber materials such as natural rubber (NR), ethylene propylene rubber (EPM) or ethylene propylene diene, phenol-formaldehide polymers such as resols (fusible resins soluble in alkali and alcohol), novolak (phenol-formaldehyde condensation polymer), resins (e.g., phenolic resin), rubbers, and various mixtures thereof. In general, these examples may be suitable for both the positive electrode binder 118 and the negative electrode binder 128. The concentration of a binder in a corresponding active material layer may be 0.1-10% by weight or, more specifically, 1-5% by weight.

In some examples, a positive-electrode active-material layer 114 and/or a negative-electrode active-material layer 124 comprises various additives that can be used to improve electrochemical, electrical, or mechanical features of the electrodes. For example, electrochemical performance can be improved by addition of nickel, nickel hydroxide, nickel oxyhydroxide, or nickel oxide containing cathode material that can incorporate or be coated with small amounts of cobalt oxide, strontium hydroxide (Sr(OH)₂), barium oxide (BaO), calcium hydroxide (Ca(OH)₂), iron oxide (Fe₃O₄), calcium fluoride (CaF₂), or yttrium oxide (Y₂O₃) to improve battery cell performance. As another example, an electrode can include an oxide such as bismuth oxide, indium oxide, and/or aluminum oxide. Bismuth oxide and indium oxide may interact with zinc and reduce gassing at the electrode. Bismuth oxide may be provided in a concentration of 1-10% by weight of a dry negative electrode formulation. Indium oxide may be present in a concentration of 0.05-1% by weight of a dry negative electrode formulation. Aluminum oxide may be provided in a concentration of 1-5% by weight of a dry negative electrode formulation.

In certain examples, one or more additives may be included to improve the corrosion resistance of the zinc electrode material. Specific examples of anions that may be included to reduce the solubility of zinc in the electrolyte include phosphate, fluoride, borate, zincate, silicate, or stearate. Generally, these anions may be present in an electrode in concentrations of up to about 10% by weight of a dry electrode formulation.

Additives that improve electrical characteristics, such as conductivity, can also be added. For example, a range of carbonaceous materials can be used as electrode additives, including powdery or fibrous carbons such as graphite, coke, ketjen black, and acetylene black. Carbonaceous nanomaterials can also be used, such as single or multiwalled carbon nanotubes, carbon nanofibers, multi-layered carbon nanoparticles, carbon nanowhiskers, or carbon nanorods. Additives may be provided as chemically homogeneous components in a mixture or solution, co-precipitated, or coated onto particles.

### Electrolytes

Electrolyte 170 can be aqueous-based, solvent-based, solid polymer, or an ionic liquid. In some examples, electrolytes can be semi-solid or gelatinized. Gelatinizing agents can include polymers that absorb the liquid of the electrolyte solution and swell. Such polymers can include polyethylene oxide, polyvinyl alcohol, and polyacrylamide. In another example, the electrolyte can be a solid-state electrolyte. In another example, an electrolyte can be formed as a solid material with absorbed water. For example, potassium hydroxide (KOH) is exposed to humid air.

In some examples, electrolyte 170 comprises one or more electrolyte solvents 172 and one or more ionic additives 174. Some examples of suitable ionic additives 174 include, but are not limited to, potassium hydroxide (KOH), sodium hydroxide (NaOH), lithium hydroxide (LiOH), calcium hydroxide (Ca(OH)₂), and inorganic salts such as zinc bromide (ZnBr₂). The concentration of the ionic additive 174 in the electrolyte 170 may be 1-45% by weight or, more specifically, 5-30% by weight. Some examples of suitable electrolyte solvents 172 include, but are not limited to, water (H₂O).

In some examples, electrolyte 170 may also comprise functional additives, such as zinc oxide (ZnO), calcium oxide (CaO), calcium hydroxide (Ca(OH)₂), and bismuth(II) oxide (Bi₂O₃), and copper oxides (e.g., copper(I) oxide (Cu₂O), copper(II) oxide (CuO), and mixed-valence copper(I, III) oxide (Cu₄O₃)). These functional additives may be used at a concentration of 0.1 weight % to the saturation limit. Electrolyte additives can be used to stabilize the long-term performance and durability of the battery. Other additives may include ethylene glycol, polyethylene glycol and its oligomers (PEG200, PEG400, PEG600 and others with higher molecular weight), ionic and non-ionic surfactants (such as Triton-X), and ammonia salts. Other types of electrolyte additives (such as cesium salts (e.g., cesium carbonate (Cs₂CO₃), cesium fluoride (CsF), and cesium sulfate (Cs₂SO₄)) and salts of quaternary ammonium compounds (e.g., tetraethylammonium chloride [N(CH₂CH₃)₄]⁺Cl⁻) tetramethylammonium hydroxide ((CH₃)₄NOH), and benzyltrimethylammonium bromide ((C₆H₅CH₂N(CH₃)₃Br)) may be used to achieve smooth and uniform plating of Zn during recharge.

In some examples, the electrolyte 170 comprises one or more gelling and/or thickening additives, e.g., polyvinyl alcohol (PVA), modified polysaccharides (like diutan gum, guar gum), synthetic polymers (like carbomers or crosslinked acrylic polymers), and biopolymers (like chitosan). Such additives help prevent electrolyte leaks if cell hermeticity is compromised. The concentration of gelling and/or thickening additives in the electrolyte may be 0.1-10% by weight or, more specifically, 0.5-5% by weight.

As further described below, a portion (substrate 132) of the separator 130 may be permeable to the electrolyte 170, while another portion (ion exchange layer 134) may be impermeable. As such, the composition of the electrolyte 170 contacting the positive electrode 110 (which may be referred to as catholyte) may be the same or different from the composition of the electrolyte 170 contacting the negative electrode 120 (which may be referred to as anolyte).

### Separators

### Structural Aspects

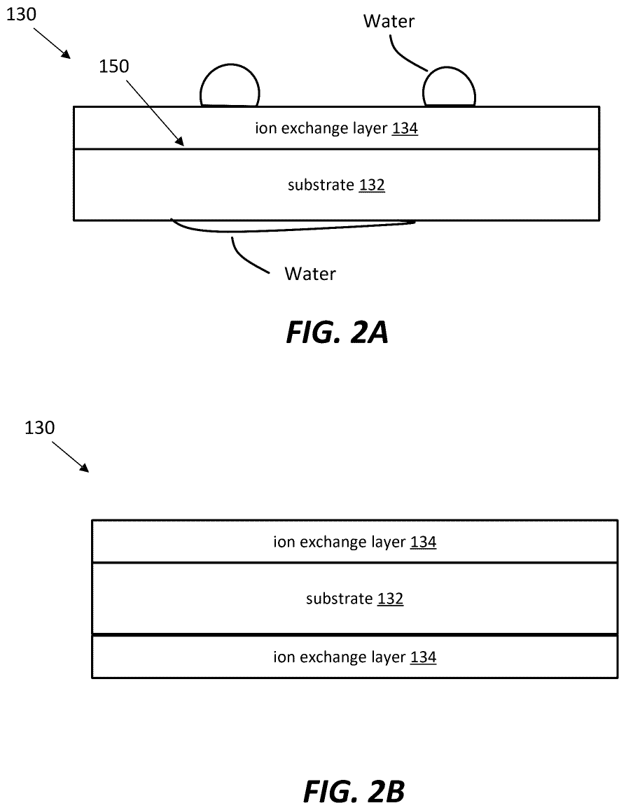

FIGS. 2A and 2B are schematic illustrations of a separator 130 that comprises a substrate 132 and supports an ion exchange layer 134. Referring to FIG. 2A, the ion exchange layer 134 may be positioned only on one side of the substrate 132, such that the other side of the substrate 132 is free from any ion exchange materials (e.g., exposed and may be generally referred to as an “uncoated side”). When a separator 130 is assembled into an electrochemical cell 100, the ion exchange layer 134 may face the negative electrode 120, while the uncoated side of the substrate 132 may face the positive electrode 110. Specifically, the ion exchange layer 134 is configured to control the zinc dendrite formation (e.g., which may otherwise penetrate through the substrate 132, blocking the membrane pores). Furthermore, a positive active material 116 (e.g., manganese dioxide (MnO₂)) may react with the ion exchange layer 134 if the ion exchange layer 134 comes in direct contact with this material.

The ion exchange layer 134 may be positioned on the surface of the substrate 132 and, in some examples, penetrate at least a portion of the substrate 132. As further described below, the substrate 132 may be a porous material with the ion exchange layer 134 filling at least a portion of these pores. This integration/interpenetration provides stronger bonding between the ion exchange layer 134 and the substrate 132 and further blocks zinc dendrites from entering the substrate pores. Overall, the separator 130 may be described as an air-tight composite structure. The interface 150 between the substrate 132 and the ion exchange layer 134 can be smooth, rough, or even interpenetrating.

Referring to FIG. 2B, in some examples, the ion exchange layer 134 may be coated on both sides of the substrate 132 (either simultaneously or sequentially). The double-sided coating may be used to maintain the structural stability of separator 130 and to avoid the separator's deformation. For example, different physical properties of the ion exchange layer 134 and the substrate 132 may cause the separator's curling, which is undesirable. Positioning the substrate 132 between two ion exchange layers 134 balances the forces at the substrate-ion exchange layer interfaces and reduces the risk of curling.

### Substrate Examples

In some examples, a substrate 132 is a porous layer, e.g., has a porosity of 10-90% or, more specifically, 40-80% (before being coated with an ion exchange layer 134). The substrate 132 or, more specifically, its pores allow the electrolyte 170 to soak the substrate 132. Specifically, the pores allow ions to pass while the substrate 132 remains chemically stable with respect to the electrolyte 170. It should be noted that ions can migrate through the ion exchange layer 134 without the need for pores in the ion exchange layer 134. As such, the ion exchange layer 134 may penetrate the pores of the substrate 132 and/or form a non-porous layer over the substrate 132 as further described below.

In some examples, the substrate 132 has one or more of the following structures: a porous non-woven layer, a woven layer, a track-etched layer, a sintered porous layer, and a stretched polymeric porous layer. In further examples, the substrate 132 comprises multiple layers of chemically and/or morphologically different materials (e.g., materials having different spatial orientation of pores, strands, or fibers).

In some examples, the ion exchange layer 134 penetrates the pores of the substrate 132 to 1-50% or, more specifically, 2-20% or even 5-15% relative to the total thickness of the substrate 132. In other examples, the ion exchange layer 134 fills most (e.g., at least 50% by volume, at least 60% by volume, at least 70% by volume, at least 80% by volume, or even at least 90% by volume) or all (100% by volume) of the pores in the substrate. Furthermore, the overall porosity of the separator 130 (a combination of both the substrate 132 and ion exchange layer 134) may be 0-80% or, more specifically, 0-20%.

In some examples, the substrate 132 has a thickness of 0.5-100 micrometers or, more specifically, 1-50 micrometers or even 2-20 micrometers. A thicker substrate is more mechanically stable (e.g., processable) and more resistant to the dendrite pressure. However, a thicker substrate takes up space and weight in the electrochemical cell 100, thereby reducing the gravimetric/volumetric capacity of the electrochemical cell 100. In addition, a thicker substrate has more resistance to ionic transport and may not be usable for applications requiring high power from the battery. For such applications, thinner substrates (e.g., with thicknesses of 20 microns or less) may be used.

In some examples, the substrate 132 comprises one or more materials selected from a group consisting of glass, polypropylene, polyethylene, resin, or any other material having long-term stability in the electrolyte of the electrochemical cell. For example, in the case of an alkaline electrolyte, the substrate materials should be stable in highly alkaline solutions. As a reference, polymers containing hydrolysable functional groups (e.g., including polyesters, polyamides, polycarbonates, polyurethanes, acetate-containing copolymers, natural biopolymers, and acrylic or methacrylic polymers) may not be suitable for the substrate 132 in alkaline batteries because they undergo alkaline-induced hydrolysis, saponification, or structural degradation that compromises mechanical and dimensional stability.

### Ion Exchange Layer Examples

In some examples, the ion exchange layer 134 is non-porous, e.g., has a porosity of less than 10%, less than 5%, or even less than 2%. As such, the electrolyte 170 does not soak into the ion exchange layer 134. Instead, the ionic transfer through the ion exchange layer 134 is performed by the material of the ion exchange layer 134. As noted above, the ion-exchange layer 134 may fill the pores of the substrate 132 entirely or at least partially.

When pores are present in the ion exchange layer 134, the pore sizes may be less than 2 micrometers, less than 1 micrometer, even less than 0.5 micrometers, or even less than 0.1 micrometers. For example, the ion exchange layer 134 may be microporous with pore sizes smaller than 1 micrometer.

For example, pores may be formed in the ion exchange layer 134 by adding an admixture of material, e.g., into a solution used to coat the ion exchange layer 134 over the substrate 132. This added material may be soluble in a solvent and/or in a battery electrolyte and is removed from the ion exchange layer 134 once in contact with the solvent and/or the battery electrolyte. Some examples of such admixture may include, but are not limited to, ethylene glycol, polyethylene oxide glycols (PEGs) of different molecular weights (e.g., PEG200 or PEG400), glucose, sucrose, sugars, or polysaccharides. The amount and the type of admixture determine the pore size and the overall porosity. Without being restricted to any particular theory, it is believed that microporosity (e.g., less than 2 micrometers, less than 1 micrometer, or even less than 0.5 micrometers) of the ion exchange layer 134 improves the overall ionic conductivity of the separator 130. However, excessive porosity and large pore sizes may actually compromise the ion-exchange and dendrite-protecting properties of the separator 130. For example, the following table illustrates changes in the relative conductivity of the ion exchange layer 134 when polyethylene glycol 200 (PEG200) is added.

| PEG200 content (% by wt) | Relative Conductivity |
|---|---|
| 0 | 1.0 |
| 1 | 1.5 |
| 2 | 2.5 |
| 4 | 3.3 |

Overall, a larger amount of PEG200 results in higher ionic conductivity of the ion exchange material.

In the same or other examples, the ion exchange layer 134 has a thickness of 0.5-50 micrometers, 1-10 micrometers, or more specifically 2-8 micrometers. A thinner ion exchange layer 134 may help to improve the cell's energy density. However, thin layers are difficult to produce (in a conformal and/or uniform manner) and may have limited mechanical and dendrite protection properties. In some examples, the non-uniformity of the thickness of the ion exchange layer 134 is less than 25%, less than 15%, or even less than 10%. The thickness uniformity helps to achieve process reproducibility during winding or stacking of the battery cell. Furthermore, the thickness uniformity ensures consistent ionic exchange, mechanical, and dendrite protection properties across the entire interface between the positive electrode 110 and the negative electrode 120.

An ion exchange layer 134 may be formed from an anion-selective ion-exchange material (alone), a cation-selective ion-exchange material (alone), or a combination of an anion-selective ion-exchange material and a cation-selective ion-exchange material. For example, anion-selective ion-exchange materials may be more ionically conductive than cation-selective ion-exchange materials and, as such, used for high-rate battery applications.

In some examples, the chemical structure of the ion exchange layer 134 comprises a base polymer 136 (e.g., forming polymeric chains), such as an organic material or a polymer. Some examples of a base polymer 136 include, but are not limited to, polystyrene, polysulfone, polyethersulfone, polyvinyl pyridine, and polyphenylene oxide. In some examples, the polymeric chains of the base polymer 136 are crosslinked with a degree of crosslinking ranging from 5% to 100% per structural repeating unit, or more specifically, from 10% to 50%. In some examples, the molecular weight of base polymer 136 is 20,000-500,000 g/mol.

In some examples, an ion exchange layer 134 comprises functional groups 138 supported on the base polymer 136. For example, functional groups 138 may be acidic, such as sulfonic acid group (—SO₂OH), carboxylic acid groups (—COOH or —CO₂H), or their salts (e.g., with sodium cations (Na⁻), potassium cations (K⁺), cesium cations (Cs⁺), and/or lithium cations (Li⁺). Acidic groups allow transport of cations through the ion exchange layer 134 and are better suited for neutral or slightly acidic electrolytes (e.g., pH of 7 or less)

In some examples, the functional groups 138 are present in the base polymer 136 from organic synthesis, not added to the membrane after casting.

In some examples, multiple different functional groups 138 may be presented (e.g., when the base polymer 136 is formed using a mixture of different polymers in one membrane).

It should be noted that the concentration of the functional groups influences the ionic conductivity of the ion exchange material. Higher concentration increases the concentration of mobile ions that can exist inside the material, resulting in higher conductivity. Higher concentration of functional groups also results in higher swelling and may lead to membrane instability or even solubility in the electrolyte. This can be mitigated by crosslinking of the polymer. The concentration of functional groups can greatly vary (10-100%) depending on polymer chemistry, crosslinking chemistry, and electrolyte. For example, one functional group can be attached to each repeating unit of the polymer chain, or one functional group can be attached to half or less (e.g., 10-50%) of the repeating units of the polymer chain, or more than one functional group can be attached to each repeating unit of the polymer chain.

In some examples, functional groups 138 are basic functional groups, such as quaternary amino groups (—NR₄⁺) or ammonium groups (—NH₄⁺) including trimethylammonium groups (—(CH₃)₃N⁺), phosphonium groups (—PR₄⁺, where R is one or more of hydrogen, alkyl, aryl, or halogen) or sulfonium groups (—SR₃⁺, where R is one or more of hydrogen, alkyl, aryl, or halogen). For example, ammonium groups (—NH₄⁺) may be used due to their stability in alkaline electrolytes. Basic functional groups allow transport of anions through the ion exchange material and are better suited for alkaline electrolytes.

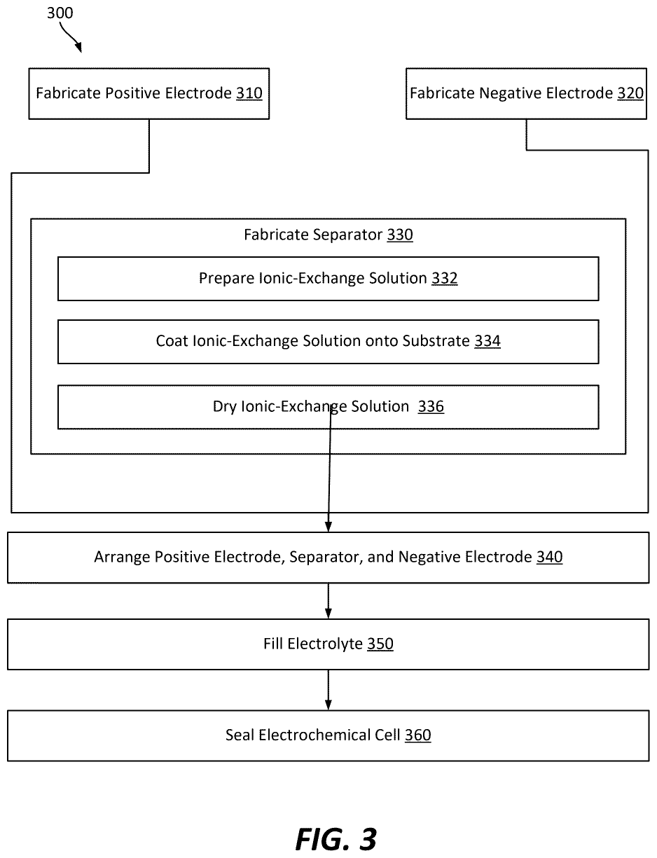

In some examples, the functional groups 138 may be integrated into the separator 130 before being incorporated into an electrochemical cell 100. This process is further described below with reference to FIG. 3.

In some examples, the ion exchange layer 134 has additives to improve the mechanical properties of the layer, such as resistance to fracturing under tensile or compressive loads. The additives can be in the form of solid particles, which may be referred to as reinforcement structures or particles. The reinforcement structures can comprise or consist essentially of one or more polymers such as, for example, polyethylene, polypropylene, cellulose, aramid, and polytetrafluoroethylene (PTFE). Alternatively, the reinforcement structures may comprise or consist essentially of ceramic, such as, for example, silica or alumina. The reinforcement structures can be essentially spherical, have an elongated shape (e.g., fibers), or have an irregular shape. For example, the particle size of the reinforcement structures may be 0.01-5 micrometers or, more specifically, 0.05-1 micrometers. The concentration of the reinforcement structures in the ion exchange layer 134 may be 1-50% by weight or, more specifically, less than 10% by weight.

In some examples, the ion exchange layer 134 is hydrophobic, e.g., to discourage absorption of water and minimize unwanted side reactions (e.g., dendrite growth, hydrogen evolution) within the ion exchange layer 134. More specifically, a water droplet positioned on the ion exchange layer 134 may have a contact angle greater than 90° or, more specifically, greater than 120° or even greater than 150°. In the same or other examples, the ion exchange layer 134 may have an electrolyte adsorption rate (weight gain when exposed to electrolyte) of less than 40%, less than 20%, less than 10%, less than 5%, or even less than 1%. In some examples, the ion exchange layer 134 may lose weight when exposed to the electrolyte, resulting in a negative electrolyte-absorption rate. In the same or other examples, the supporting substrate 132 is hydrophilic (able to absorb and retain water droplets).

### Processing Examples

FIG. 3 is a process flowchart corresponding to method 300 of fabricating an electrochemical cell 100, in accordance with some examples. Various components and features of electrochemical cells 100 are described above.

Method 300 may comprise (block 310) fabricating a positive electrode 110 and, in a separate operation, (block 320) fabricating a negative electrode 120. For example, various electrode materials (e.g., active materials and binders) may be dry mixed. This dry mixture may be heated, fused, and/or compressed to form a corresponding active material layer. In some examples, these operations may be performed after placing the dry mixture into a battery case.

In some examples, materials forming a positive-electrode active-material layer 114 (and/or, separately, materials forming the negative-electrode active-materials layer 124) are mixed with a solvent to form a viscous mixture that is extruded as a positive-electrode active-material layer 114 (or a negative-electrode active-materials layer 124) of any geometry. For example, this extraction may have a thickness of 20-1,000 micrometers or, more specifically, 100-500 micrometers. The extrusion may be placed on the corresponding current collector (e.g., a positive-electrode current collector 112 or a negative-electrode current collector 122). After this placement, the stack comprising the current collector and the active-materials layer extrusion is pressurized in order to facilitate the penetration of the active-materials layer extrusion into the current collector (e.g., comprising pores such as being a foam) and to ensure the adhesion of the active-materials layer extrusion and the current collector.

Alternatively, a wet mixing process may instead be utilized to fabricate electrodes. For example, one or more solvents may be added (e.g., to a dry mixture) at the beginning or during the mixing process to form a slurry (dispersion/suspension). Once the slurry is coated onto a current collector, the solvent can be removed.

Method 300 may comprise (block 330) fabricating a separator 130. Specifically, a separator 130 may be fabricated as a standalone structure and later arranged together with the positive electrode 110 and negative electrode 120. Without being restricted to any particular theory, it is believed that a freshly fabricated separator 130 often contains residual solvents, impurities, etc. As such, depending on fabrication techniques, the separator 130 may initially have different conductivity mechanisms (electronic and/or ionic). Separator conditioning may be used to achieve desirable properties. Specifically, this conditioning improves ionic conductivity and reduces the initial resistance. The conditioning may also minimize any residual stresses and chemical degradation during operation. Specifically, the conditioning helps to “chemically align” the separator 130 with a corresponding electrolyte and/or with any other operating environment.

At block 332, an ionic-exchange solution is prepared. In some examples, the solution comprises a base polymer such as polystyrene, polysulfone, or polyethersulfone, together with a solvent and one or more additives. Chemical compounds having functional groups, such as sulfonic acid groups or quaternary ammonium groups, or functional groups that form ionic functional groups when reacted with the base polymer chain, may be incorporated directly into the solution or introduced in a later post-treatment step. The viscosity and concentration of the ionic-exchange solution may be adjusted to control penetration into the pores of substrate 132 and to define the thickness of the resulting ion exchange layer 134.

At block 334, the ionic-exchange solution is applied to the substrate 132. Coating may be performed by techniques such as casting, spraying, dip coating, slot-die coating, or printing. The coating process may be one-sided or two-sided, depending on whether the separator 130 is intended to have one or two ion exchange layers 134. During coating, a portion of the solution may infiltrate the pores of the substrate 132, typically penetrating 1-100% of the substrate thickness to form an interpenetrating interface 150 that mechanically anchors the two layers together.

At block 336, the coated ionic-exchange solution is dried under controlled temperature. Drying removes solvent, consolidates the polymer structure, and forms a continuous ion exchange layer 134 on the substrate 132. In some examples, the drying process is conducted in multiple stages, with an initial ambient drying step followed by thermal curing or vacuum treatment.

The ion exchange process can be a single-stage process or a multi-stage process, with each stage resulting in a complete or partial exchange of counter ions on the ion exchange functional groups. For example, if the concentration and contact time are sufficient, nearly all counter-ions may be replaced in one step. However, in some cases, the exchange doesn't go to completion in one step (e.g., due to kinetics, concentration limits, and/or diffusion barriers). As a result, the process needs to be repeated multiple times (in multiple stages). During each stage, some fraction of the remaining ions gets exchanged until the process is complete (or almost complete). Each stage of the process can have a different counter-ion that participates in the ion-exchange process. In this case, the sequence of ions in the multi-stage ion-exchange process is selected to facilitate faster kinetics of the ion-exchange reaction and higher conductivity of the ion-exchange material.

In the case when the ion exchange material is an anion exchange material, the counter ions can be selected from the list including but not limited to bromide (Br⁻), chloride (Cl⁻), hydroxide (OH⁻), sulfate (SO₄²⁻), acetate (CH₃COO⁻), nitrate (NO₃⁻), borate (BO₃³⁻ or related borate species), carbonate (CO₃²⁻), hydrogencarbonate/bicarbonate (HCO₃⁻), and phosphate species (PO₄³⁻ and related forms). In the case when the ion exchange material is a cation exchange material, the counter ions can be selected from the list, including but not limited to sodium cations (Na⁺), potassium cations (K⁺), lithium cations (Li⁺), protons (H⁺), or hydronium cations (H₃O⁺).

The pre-treatment process can include a set of rinsing steps (e.g., using water, water mixed with one or more alcohols/other co-solvents to remove possible residue of the chemicals used in the previous ion-exchange steps from the surface of the separator).

The pre-treatment process can be followed by one or several drying steps. Drying steps can include wiping steps, air (or other gas) blowing, and heating. The drying steps are utilized to remove residual liquid from the surface of the separator so that it can be used for cell assembly.

At block 340, the positive electrode 110, separator 130, and negative electrode 120 are arranged together to form a cell stack. The separator 130 is positioned between the positive electrode 110 and the negative electrode 120 such that the ion exchange layer 134 faces the negative electrode 120, while the uncoated side of the substrate 132 faces the positive electrode 110. The electrodes and separator may be wound, stacked, or otherwise configured to conform to the desired cell geometry, including cylindrical, prismatic, pouch, or coin-type formats.

At block 350, the assembled stack is filled with electrolyte 170. In some examples, the electrolyte comprises an aqueous alkaline solution, such as potassium hydroxide, sodium hydroxide, or lithium hydroxide, optionally containing functional additives including zinc oxide. The electrolyte filling process may be assisted by vacuum, pressure, or capillary imbibition, and may fully or partially soak into the pores of the substrate 132 of the separator 130 and electrodes and ion exchange layer 134. Parts of the cell, such as electrode binders, ion exchange material, and separator substrate material, may also absorb electrolyte or portions of electrolyte into their structure by swelling.

At block 360, the electrochemical cell 100 is sealed to form a complete unit. In some examples, the sealing operation includes crimping, heat sealing, or welding of a casing 180. Sealing may be performed under controlled environmental conditions to minimize contamination. The sealed casing 180 provides mechanical protection, prevents leakage of the electrolyte 170, and ensures long-term stability of the cell during operation and storage.

### Experimental Results

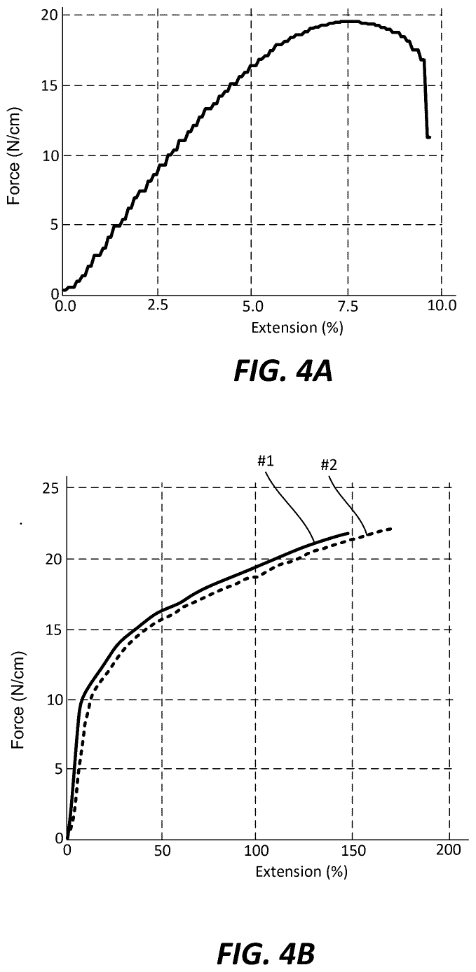

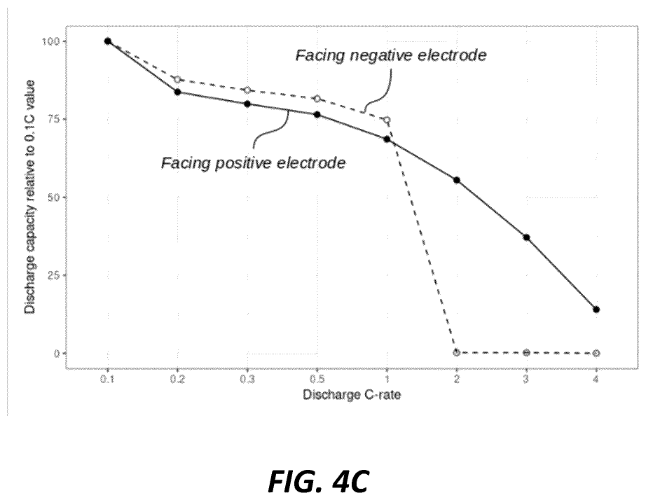

FIGS. 4A and 4B compare the mechanical properties of a standalone ion exchange film (FIG. 4A) and a separator comprising a substrate and an ion exchange layer coated on the substrate (FIG. 4B). Each sample was cut as a 1″×4″ strip and loaded into mechanical pull tester with one end of the strip fixed in a non-moving clamp and the opposite end of the strip fixed into a clamp that moves at a fixed speed. The sample was pulled at a constant speed of 23.2 mm/min at room conditions until breaking. FIG. 4A illustrates that the standalone ion exchange film is rather inflexible, i.e., the film extended only about 9% of the initial film length before breaking. The separator with a substrate and an ion exchange layer is substantially more flexible, as shown in FIG. 4B and extended about 150% of the initial film length before breaking. Flexibility is quite beneficial for various types of electrochemical cells, especially zinc-based alkaline cells that undergo substantial swelling, which applies various stresses to a separator. Specifically, FIG. 4B illustrates results for the separator comprising a substrate and an ion exchange film.

In another experiment, a standalone ion exchange film and a separator comprising a substrate and an ion exchange layer coated on the substrate (similar to the samples described above with reference to FIGS. 4A and 4B) were tested to a stability in a potassium hydroxide (KOH) solution, e.g., with the KOH concentration of 50-400 g/L or, more specifically, 260-290 g/L. The standalone ion exchange film was quite unstable in the potassium hydroxide (KOH) solution. Specifically, the standalone ion exchange film almost immediately lost its mechanical integrity and shape. Within a couple of minutes, the standalone ion exchange film transformed into a shapeless ball of gel. On the other hand, the separator (with the substrate and ion exchange layer) was very stable, i.e., maintained its shape, dimensions, and color.

In yet another experiment, a polyethylene (PE) substrate was coated with an ion exchange layer. The cross-section of the resulting composite separator was analyzed under high magnification to determine the level of penetration of the ion exchange layer into the substrate. Specifically, the polyethylene (PE) substrate had a thickness of about 5 micrometers. The ion exchange layer's thickness was about 11.5 micrometers (at least for the portion of the ion exchange layer positioned outside and stacked with the PE substrate). Finally, a portion of the ion exchange material solution penetrated into the PE substrate, creating a thinner embedded layer, which measured about 5.3 micrometers thick.

A further experiment established differences in electrochemical cell power capability depending on the orientation of the asymmetric separator comprising a porous polyethylene substrate with its pores filled with ion exchange material and one side supporting a thick layer of the ion exchange material. In this experiment, the ion exchange material contained basic functional groups and was an anion exchange material. The separator was used to assemble a rechargeable MnZn battery cell (pouch cells) with one positive electrode comprising EMD active material and one negative electrode comprising a mixture of Zn and ZnO active materials. A KOH solution in water was used as the electrolyte. Each cell was rated with a capacity of about 150 mAh, calculated as a theoretical capacity of the EMD material in the positive electrode, assuming discharge of two electrons. Both cells were then subjected to various constant current discharge rates with a 0.7V lower cutoff voltage. The discharge current was calculated based on the cell's rated capacity, with subsequent discharge rates shown as C-rates in the table below. Each discharge step was followed by 10 10-minute rest step and a CCCV charge step to 1.8V with a cutoff current of C/80, then discharge with the next C-rate was done on the same cell. A first group of cells was assembled with the thicker layer of the ion exchange material facing towards the negative electrode (“facing negative electrode” in FIG. 4C). A second group of cells was assembled with the thicker layer of the ion exchange material on the separator facing the positive electrode (“facing positive electrode” in FIG. 4C).

FIG. 4C illustrates the test results for both groups of cells. Average values among each cell group are plotted (5 cells per group were tested). It was found that the rate capability depends on the separator orientation between the electrodes, with higher rate capability achieved when the side of the separator with the thicker layer of the ion exchange material faces the positive electrode.

### CONCLUSION

Many modifications and other examples of the invention will come to the mind of one skilled in the art, having the benefit of the teachings presented in the foregoing descriptions and the associated drawings. Therefore, it is understood that the invention is not to be limited to the specific examples disclosed, and that modifications and examples are intended to be included within the scope of the appended claims. It is also understood that other examples of this invention may be practiced in the absence of an element/step not specifically disclosed herein.

1. An electrochemical cell comprising:
a positive electrode comprising manganese dioxide as a positive active material;
a negative electrode comprising one or more of zinc and zinc oxide as a negative active material; and
a separator positioned between the positive electrode and the negative electrode, wherein:
the separator comprises a porous substrate and an ion exchange layer supported on at least one side of the substrate,
the substrate comprises a material selected from the group consisting of glass, polyethylene, polypropylene, cellulose, resin, and polyamide,
the ion exchange layer comprises one or more functional groups selected from a carboxylic acid group, a quaternary ammonium group, an ammonium group, a phosphonium group, a sulfonium group, and
the ion exchange layer faces the negative electrode.

2. The electrochemical cell of claim 1, wherein the ion exchange layer is substantially non-porous with a porosity less than 5%.

3. The electrochemical cell of claim 1, wherein the substrate has a porosity between 40-80% before coating with the ion exchange layer.

4. The electrochemical cell of claim 1, wherein the ion exchange layer penetrates at least 20% of a thickness of the substrate and forms an interpenetrating interface.

5. The electrochemical cell of claim 1, wherein the ion exchange layer fills substantially all pores in the substrate.

6. The electrochemical cell of claim 1, wherein the ion exchange layer is microporous with pore sizes smaller than 1 micrometer.

7. The electrochemical cell of claim 1, wherein the ion exchange layer has a thickness of 1-10 micrometers.

8. The electrochemical cell of claim 1, wherein the substrate has a thickness between 1-50 micrometers.

9. The electrochemical cell of claim 1, wherein the substrate is hydrophilic, and the ion exchange layer is hydrophobic.

10. The electrochemical cell of claim 9, wherein the negative electrode further comprises additives selected from bismuth oxide, indium oxide, or aluminum oxide.

11. The electrochemical cell of claim 1, wherein the separator exhibits elongation at break greater than 20%.

12. The electrochemical cell of claim 1, wherein the substrate comprises a non-woven polymeric layer.

13. The electrochemical cell of claim 1, wherein the separator comprises an additional ion exchange layer such that the porous substrate is positioned between the ion exchange layer and the additional ion exchange layer.

14. The electrochemical cell of claim 13, wherein the ion exchange layer and the additional ion exchange layer have different thicknesses.

15. The electrochemical cell of claim 1, wherein the ion exchange layer comprises a base polymer such that one or more functional groups are on 10-50% of repeating units of the base polymer.

16. The electrochemical cell of claim 15, wherein the base polymer is selected from the group consisting of polystyrene, polysulfone, polyethersulfone, and polyphenylene oxide.

17. The electrochemical cell of claim 1, wherein the ion exchange layer exhibits an electrolyte absorption rate of less than 5%.

18. The electrochemical cell of claim 1, wherein the substrate absorbs at least 20% of its weight in electrolyte.

19. A method of fabricating an electrochemical cell, the method comprising:
fabricating a positive electrode comprising manganese dioxide as a positive active material;
fabricating a negative electrode comprising one or more of zinc and zinc oxide as a negative active material;
fabricating a separator comprising a substrate and an ion exchange layer supported on at least one side of the substrate, wherein:
the substrate comprises a material selected from the group consisting of glass, polyethylene, polypropylene, cellulose, resin, and polyamide, and
the ion exchange layer comprises one or more functional groups selected from a carboxylic acid group, a quaternary ammonium group, an ammonium group, a phosphonium group, a sulfonium group; and
arranging the positive electrode, the separator, and the negative electrode such that the separator is positioned between the positive electrode and the negative electrode and such that the ion exchange layer faces the negative electrode.

20. The method of claim 19, wherein fabricating the separator comprises:
preparing an ion-exchange solution,
coating the ion-exchange solution onto the substrate such that the ion-exchange solution penetrates at least 20% of a thickness of the substrate and forms an interpenetrating interface; and
drying the ion-exchange solution to form the ion exchange layer.
